(19) United States
(12) Patent Application Publication
(10) Pub. No.: US 2025/0370763 A1
(43) Pub. Date: Dec. 4, 2025

(54) SYSTEMS AND METHODS FOR CONTAINER BASED MULTIPLE OPERATING SYSTEM DELIVERY WITH LIMITED RAM

(71) Applicant: QUALCOMM Incorporated, San Diego, CA (US)

(72) Inventors: Zhuo FU, Shanghai (CN); Zhou GAO, Shanghai (CN); Sheng FANG, Shanghai (CN)

(21) Appl. No.: 18/873,301

(22) PCT Filed: Jun. 22, 2022
(86) PCT No.: PCT/CN2022/100377

§ 371 Date: Dec. 9, 2024

(51) Int. Cl. G06F 9/4401

(52) U.S. Cl. CPC G06F 9/4406

(57) ABSTRACT

Systems and methods for using containers in computing devices (e.g., IOT devices, etc.) to host multiple operating system (OS) user spaces that share the same kernel may include a computing device configured to intelligently and dynamically switch the currently active container to another container in response to detecting a trigger, event, or condition on the computing device. The computing device may also dynamically activate or deactivate all or portions of one or more memories of the computing device based on the characteristics and/or workload of the currently active container.

### BACKGROUND

Computing devices that include wireless communication capabilities are becoming smaller, cheaper, and increasingly ubiquitous. Increasingly, such computing devices and wireless communication capabilities are being incorporated into more objects, gradually creating a massively distributed network of computing devices generally referred to as the Internet of Things (IOT). For these and other reasons, modern residential and commercial computer networks are being increasingly populated by IOT devices.

IOT devices may communicate and interact with other devices to accomplish a variety of tasks. Some of these tasks are complex tasks that require complex operating systems (OS) and/or robust memory, processing, and/or energy resources. Others are much more simple tasks for which the use of a complex operating system and/or a large amount of memory may consume an excessive amount of the device's often limited resources (e.g., battery resources, etc.).

### SUMMARY

The various aspects include methods, and computing device (e.g., IOT devices) executing the methods, for using software containers to host multiple operating system (OS) user space instances that share a kernel to support applications that execute in different operating systems. The various aspects may include operating, by a processor in the computing device on the kernel of the computing device, a first container associated with a first OS user space instance as a currently active container, and switching the currently active container to a second container associated with a second OS user space instance based on a detected condition on the computing device.

Some aspects may further include activating or deactivating a portion of a memory of the computing device in response to switching the currently active container to the second container associated with the second OS user space instance.

In some aspects, switching the currently active container to the second container associated with the second OS user space instance based on the detected condition on the computing device may include switching the currently active container to the second container associated with the second OS user space instance in response to receiving a trigger from an external source.

In some aspects, switching the currently active container to the second container associated with the second OS user space instance based on the detected condition on the computing device may include switching the currently active container to the second container associated with the second OS user space instance in response to receiving user input on the computing device.

In some aspects, switching the currently active container to the second container associated with the second OS user space instance based on the detected condition on the computing device may include switching the currently active container to the second container associated with the second OS user space instance based on an operating condition of a software application program operating on the computing device.

In some aspects, switching the currently active container to the second container associated with the second OS user space instance based on the operating condition of the software application program operating on the computing device may include switching the currently active container to the second container associated with the second OS user space instance based on at least one of a performance characteristic of the software application program, a memory usage characteristic of the software application program, or an energy consumption characteristic of the software application program. In some aspects, switching the currently active container to the second container associated with the second OS user space instance based on the detected condition on the computing device may include switching the currently active container to the second container associated with the second OS user space instance based on at least one of an amount of time the processor has remained idle, an amount of memory used by the processor, or an amount of energy used by the processor.

In some aspects, switching the currently active container to the second container associated with the second OS user space instance based on the detected condition on the computing device may include switching the currently active container to one of a container associated with an OpenWrt user space instance, a container associated with a Linux embedded user space instance, a container associated with an Ubuntu user space instance, or a container associated with an Android user space instance. In some aspects, the computing device is an internet of things (IOT) device.

Further aspects may include a computing device having a memory that include memory segments that can each be activated or deactivated, a processor coupled to the memory and configured to support multiple operating system (OS) user space instances that share a kernel by performing operations of any of the methods summarized above. Further aspects may include a computing device having various means for performing functions of any of the methods summarized above. Further aspects may include a non-transitory processor-readable storage medium having stored thereon processor-executable instructions configured to cause a processor to perform operations of any of the methods summarized above.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of various embodiments.

FIG. 1 is a block diagram illustrating a computing system that may be configured to use containers to host multiple OS user spaces that share the same kernel in accordance with some embodiments.

FIGS. 2A and 2B are block diagrams illustrating components, operations, and communications in a computing system that is configured to dynamically switch a currently active container to another container in accordance with some embodiments.

FIGS. 3A-3C are block diagrams illustrating memory banks that may be dynamically activated or deactivated in accordance with some embodiments.

FIGS. 4-6 are process flow diagrams that illustrate methods of operating multiple OS user space instances that share a kernel in accordance with various embodiments.

FIG. 7 is a component block diagram illustrating components in systems-on- chip devices that may be configured to implement various embodiments.

FIG. 8 is a component block diagram of an example computing device, in the form of smartphone, that is suitable for implementing various embodiments.

FIGS. 9A and 9B are component block diagrams example IOT devices suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

In overview, various embodiments include methods, and computing devices configured to implement the methods, for using software containers in computing devices (e.g., IOT devices, etc.) to host multiple OS user spaces that share the same kernel. Typically, an operating system kernel runs only one container at a time. In various embodiments, the computing device may be configured to intelligently and dynamically switch the currently active container to another container based on an event or condition on the computing device and/or in response to detecting a trigger (automatic or manual). The computing device may also dynamically activate or deactivate (e.g., power off, deenergize, turn off, etc.) all or portions of one or more memories of the computing device in response to switching the currently active container and/or based on the event, condition, or trigger.

Various embodiments may allow the same computing device (e.g., an IOT device, etc.) to operate with low power consumption while executing lightweight applications that require minimal processing (e.g., point of sales, electronic shelf displays and similar applications that require very low power consumption and memory usage), and also support access-rich features for heavyweight applications that require much greater processing capabilities (e.g., video playback and other applications that require more complex OS features and larger memory). In addition, various embodiments facilitate maintenance of a common Kernel source code, and support different memory size setups, the use of multiple OS specific features at the same time, and the dynamic activation and deactivation of OS specific features on the computing device. Other additional improvements to the performance and functioning of the computing device will be evident from the disclosures herein.

By intelligently and dynamically switching the currently active container, and dynamically activating or deactivating all or portions of the memories, various embodiments allow the computing device to process a variety of different tasks while balancing tradeoffs between the performance, memory usage and/or power consumption characteristics of the computing device. Thus, various embodiments may improve the performance and energy consumption characteristics of the computing device. Such improvements may be of particular benefit in computing devices that have limited resources, such as limited memory capacity and/or limited battery power as is typical in many types of IOT devices.

The term “computing device” is used herein to refer to any one or all of internet-of-things (IOT) devices (e.g., point-of-sale devices, electronic shelf displays, smartwatches, smart televisions, smart speakers, smart locks, lighting systems, smart switches, smart plugs, smart doorbells, smart doorbell cameras, smart air pollution/quality monitors, smart smoke alarms, security systems, smart thermostats, etc.), personal computers, laptop computers, tablet computers, user equipment (UE), smartphones, personal or mobile multi-media players, personal data assistants (PDAs), palm-top computers, wireless electronic mail receivers, multimedia Internet enabled cellular telephones, gaming systems, wearable devices (e.g., smartwatch, head-mounted display, fitness tracker, etc.), media players, digital video recorders (DVRs), Internet access gateways, modems, routers, network switches, residential gateways, access points, integrated access devices (IAD), mobile convergence products, networking adapters, multiplexers, and other similar devices that include a programmable processor and communications circuitry for providing the functionality described herein.

The term “system on chip” (SOC) is used herein to refer to a single integrated circuit (IC) chip that contains multiple resources and/or processors integrated on a single substrate. A single SOC may contain circuitry for digital, analog, mixed-signal, and radio-frequency functions. A single SOC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SOCs may also include software for controlling the integrated resources and processors, as well as for controlling peripheral devices.

The term “system in a package” (SIP) is used herein to refer to a single module or package that contains multiple resources, computational units, cores and/or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP may also include multiple independent SOCs coupled together via high speed communication circuitry and packaged in close proximity, such as on a single motherboard or in a single wireless device. The proximity of the SOCs facilitates high speed communications and the sharing of memory and resources.

The term “multicore processor” is used herein to refer to a single integrated circuit (IC) chip or chip package that contains two or more independent processing cores (e.g., CPU core, Internet protocol (IP) core, graphics processor unit (GPU) core, etc.) configured to read and execute program instructions. A SOC may include multiple multicore processors, and each processor in an SOC may be referred to as a core. The term “multiprocessor” is used herein to refer to a system or device that includes two or more processing units configured to read and execute program instructions.

The term “container” is used herein to refer to a software component that enables the abstraction (or virtualization) of computing resources and/or separates application programs from their underlying infrastructure, (thus making them infrastructure agnostic). Containers operate on a containerization platform (e.g., Docker, Rocket, Linux Containers (LXC), etc.) and shared host operating system kernel. That is, each container may be one of many isolated user space instances operating on the same shared host operating system kernel, but which operate under the illusion of having full or exclusive access to the processors, peripherals, memory and I/O of the computing system.

Application programs running inside of a container may only see the container's contents and resources assigned to that container. In addition to these isolation mechanisms, the containerization platform may include a container management system and/or resource-management features that further limit the impact of one container's activities on other containers.

Containers are typically only a few megabytes in size, and thus provide an effective and efficient way to virtualize an operating system so that multiple workloads can run on a single shared host operating system kernel on a resource constrained computing device.

A virtual machine (VM) is a software solution that provides an interface between application programs and the physical hardware, potentially allowing application programs tied to a specific instruction set architecture (ISA) to execute on hardware implementing a different ISA. Virtual machine solutions may include a “hypervisor” or virtual machine monitor (VMM) that runs on actual hardware (native) or on top of an operating system (hosted) to emulate the hardware ISA and/or to otherwise provide the application programs with virtualized hardware resources. Each virtual machine may have its own separate operating system image, binaries, libraries, and software applications. As such, each virtual machine may be many gigabytes in size.

There are many well-known differences between virtual machines and containers. One important difference is that containers run on a shared host operating system kernel, whereas virtual machines run on a hypervisor or VMM that emulates the hardware ISA. In addition, each virtual machine may be many gigabytes in size, whereas containers are typically only a few megabytes each.

Many operating system kernels are organized into a user space and a kernel space. This separation may serve to provide protection from malicious or poorly-designed software. Generally, the kernel space is reserved for running a privileged operating system kernel, kernel extensions, device drivers, and other critical or security sensitive components of the operating system. On the other hand, the user space may be used to client application software.

Many computing devices (e.g., IOT devices) are multi-use devices that run a variety of different software applications that allow their users to accomplish a variety of different tasks. For example, a handheld IOT device may be equipped with point of sales software, quick response (QR) code scanning software, and multimedia streaming software. The point of sales and QR code scanning software applications may be “lightweight applications” that only require a thin client software application operating on a lightweight operating system (e.g., OpenWRT, etc.) with a small memory footprint. On the other hand, the multimedia streaming software may be “heavyweight application” that requires or benefits from a more robust client software application operating on a much more heavyweight, robust or complex operating system (e.g., Linux Embedded, Android, etc.) with more features and a larger memory footprint.

Another example of an IOT device that may benefit from various embodiments is a wearable device, such as a smartwatch, smart necklace and the like. For example, a smartwatch presenting only display of the time may be executing a lightweight application in a low power mode, but may switch to a heavyweight application to present video, measure user physiological parameters, etc.

Another example of an IOT device that may benefit from various embodiments is an electronic shelf display, which may be executing a lightweight application in a low power mode when displaying static information, such as product information and prices, but may switch to a heavyweight application to receive and display a multimedia stream, interact with wireless devices of nearby customers, etc.

To support the variety of different software applications, a computing device may be configured with an operating system that is suitable for operating its most complex software application (e.g., a multimedia streaming in the example above). Yet, when running thin client software applications, such a solution may require the use of an excessive amount of the computing device's memory, processing and/or battery resources. This may have a significant negative or user perceivable impact on the device's responsiveness or battery life, and/or otherwise degrade the user experience.

Various embodiments may equip the computing device with containers and/or container technologies that allow multiple OS user space instances to share the same kernel. Each OS user space instance may host a different operating system instance. The computing device may be configured to intelligently and dynamically switch the containers so that the currently active operating system instance is commensurate with the current software application. The computing device may also dynamically activate or deactivate portions of its memory based on the currently active operating system instance and/or the currently active software application.

For example, in some embodiments, the computing device may be configured to operate multiple OSs user space instances that share a kernel of a computing device by operating, on the kernel of the computing device, a first container associated with a first OS user space instance as a currently active container. The computing device may monitor various operations and events (e.g., context switches, system events, state changes, actions or operations of software applications, etc.) on the computing device, collect information pertaining to the monitored operations/events, and analyze the collected information to determine whether an actionable condition is present on the computing device. In some embodiments, the computing device may generate a trigger to shift containers in response to determining that there is an actionable condition is present on the computing device. In some embodiments, the computing device may switch the currently active container to a second container associated with a second OS user space instance based on a detected condition on the computing device (or in response to detecting a trigger). In some embodiments, the computing device may and activate or deactivate a portion of a memory of the computing device based on a detected condition on the computing device (or in response to detecting a trigger).

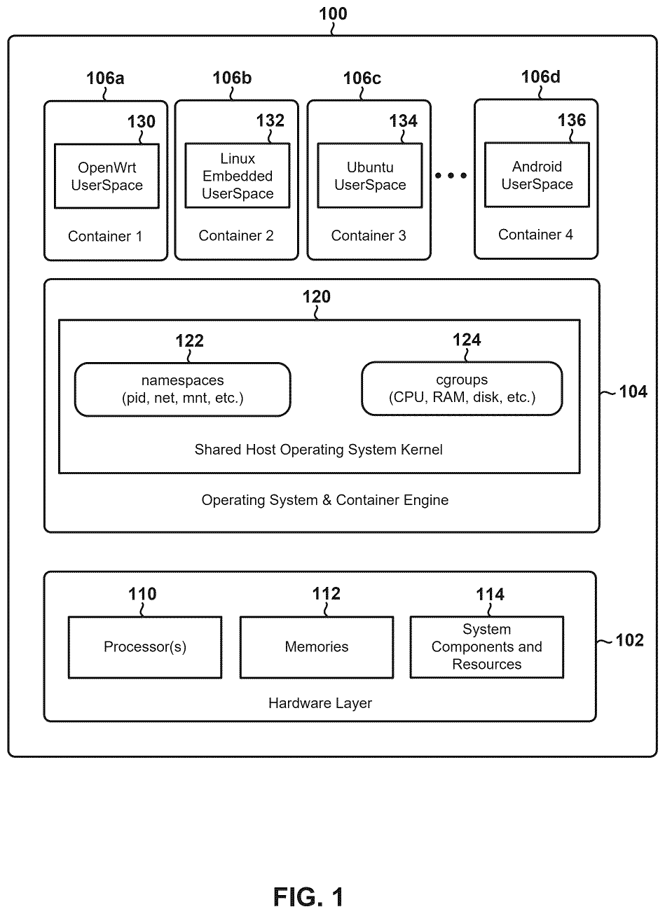

FIG. 1 illustrates an example computing system 100 that could be configured to use containers to host multiple OS user spaces that share the same kernel in accordance with some embodiments. In the example illustrated in FIG. 1, the computing system 100 includes a hardware layer 102, an operating system and container engine 104, and multiple containers 106a-106d.

The hardware layer 102 may include one or more processors 110, memories 112 and various other system components and resources 114. As examples, the processors 110 may include a digital signal processor (DSP), a modem processor (e.g., 5G modem processor, etc.), a graphics processor, an application processor, coprocessors, etc., any or all of which may operate as central processing unit (CPU) of the computing system 100 to carry out the instructions of software application programs (e.g., by performing the arithmetic, logical, control, and input/output operations specified by the instructions). In some embodiments, any or all of the one or more processors 110 may be coupled to any or all of the memories 112 and configured to support multiple OS user space instances that share a kernel (e.g., the shared host operating system kernel 120, etc.).

The memories 112 may include any of number of different types of memories and/or memory technologies. Examples of memories 112 include phase change memory (PRAM), dynamic random-access memory (DRAM), static random-access memory (SRAM), non-volatile random-access memory (NVRAM), pseudo static random-access memory (PSRAM), double data rate synchronous dynamic random-access memory (DDR SDRAM), and other random-access memory (RAM) and read- only memory (ROM), and other memories or technologies known in the art. Each of the above-mentioned memory technologies include, for example, elements suitable for storing instructions, programs, control signals, and/or data for use in or by a computer or other digital electronic device. In some embodiments, any or all of the memories 112 may include memory segments that can be activated or deactivated independently (i.e., independent of the other memory segments).

The system components and resources 114 may include various components used to support the processors and application programs running on the computing device, such as clocks, voltage regulators, oscillators, phase-locked loops, peripheral bridges, data controllers, circuitry for interfacing with peripheral devices (e.g., cameras, electronic displays, wireless communication devices, external memory chips, etc.), system controllers, access ports, timers, etc.

The operating system and container engine 104 may include a shared host operating system kernel 120 that includes a namespaces 122 component and a cgroups 124 component. The operating system and container engine 104 may also include a container engine or containerization platform (e.g., Docker, Rocket, Linux Containers (LXC), etc.) suitable for spawning and managing the containers and their associated resources.

Each of the containers 106a-d may include an isolated user space operating system instance 130-136, such as the illustrated OpenWrt user space instance 130, Linux embedded user space instance 132, Ubuntu user space instance 134, and Android user space instance 136. All of the user space operating system instances 130-136 may operate on the same shared host operating system kernel 120, but under the illusion of having full and exclusive access to the processors, peripherals, memory and I/O of the computing system 100.

In some embodiments, the computing system 100 may be configured to generate the triggers based on user input. In some embodiments, the computing system 100 may be configured to generate the triggers automatically based on current, observed, determined, anticipated, or estimated energy, memory, and/or performance (e.g., workload, etc.) requirements or characteristics of the computing system 100 or application program. As examples, the computing system 100 may be configured to generate the triggers based on the amounts of one or more memories 112 used by an application program, the amount of time that one or more of the processors 110 has remained idle, the amount of time that the application program has remained in the idle state, the types of workloads present on the device, so as to achieve improved performance per watt of expended power, to balance tradeoffs between performance and power consumption on the computing device, etc.

In some embodiments, only one of the user space operating system instances 130-136 may be active on the computing system 100, and the computing system 100 may be configured to dynamically switch the currently active container 106 to another container 106 in response to detecting the trigger for doing so.

In some embodiments, the computing system 100 may be configured to dynamically activate or deactivate all or portion of one or more of the memories 112 in response to receiving a trigger and/or based on the energy, memory, and/or performance (e.g., workload, etc.) requirements or characteristics of the computing system 100 or application program. For example, the computing system 100 may dynamically power off, deenergize, deactivate, or turn off all or portions of one or more of the memories 112 in the computing system 100 in response to determining that the currently active container 106 includes an OpenWrt user space instance 130 that does not require a large amount of processing or memory resources. Similarly, the computing system 100 may dynamically power on, energize, activate, or turn on all or portions of one or more of the memories 112 in response to determining that the currently active container 106 includes an Android user space instance 136 that requires a large amount of processing and/or memory resources.

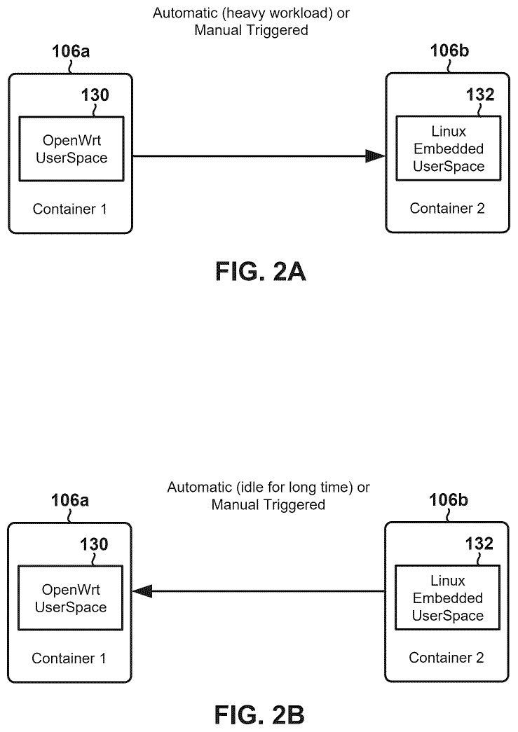

FIGS. 2A and 2B illustrate components and operations in a computing system configured to dynamically switch a currently active container to another container in response to detecting a trigger in accordance with some embodiments.

With reference to FIGS. 1-2A, the computing system may generate a trigger indicating that there is or will be an increase in the performance (e.g., workload), memory and/or energy requirements of an application program or computing system. In various embodiments, the computing device may generate a trigger in response to user input, based on the operations or characteristics of an application program, based on a result of monitoring resource usage on the computing device, etc. In response to detecting the trigger that indicate that there is or will be an increase in the performance requirements, the computing system may switch from using the container 106a that includes the OpenWrt user space instance 130 to the container 106b that includes a Linux embedded user space instance 132.

With reference to FIG. 1-2B, the computing system may generate a trigger indicating that there has been a decrease in the performance, memory and/or energy requirements of the application program. For example, the computing system may monitor the operations of the application program, determine the amount of time that the application program has remained idle, determine whether the amount of time that application program has remained idle exceeds a threshold value, and generate the trigger in response to determine that an amount of time exceeds the threshold value. In response to detecting the trigger that indicate that there has been a decrease in the performance requirements, the computing system may switch from using the container 106b that includes a Linux embedded user space instance 132 to the container 106a that includes the Open Wrt user space instance 130.

In some embodiments, the computing system may be configured to determine the threshold value and/or whether to generate the trigger so as to balance tradeoffs between performance and power consumption on the computing device.

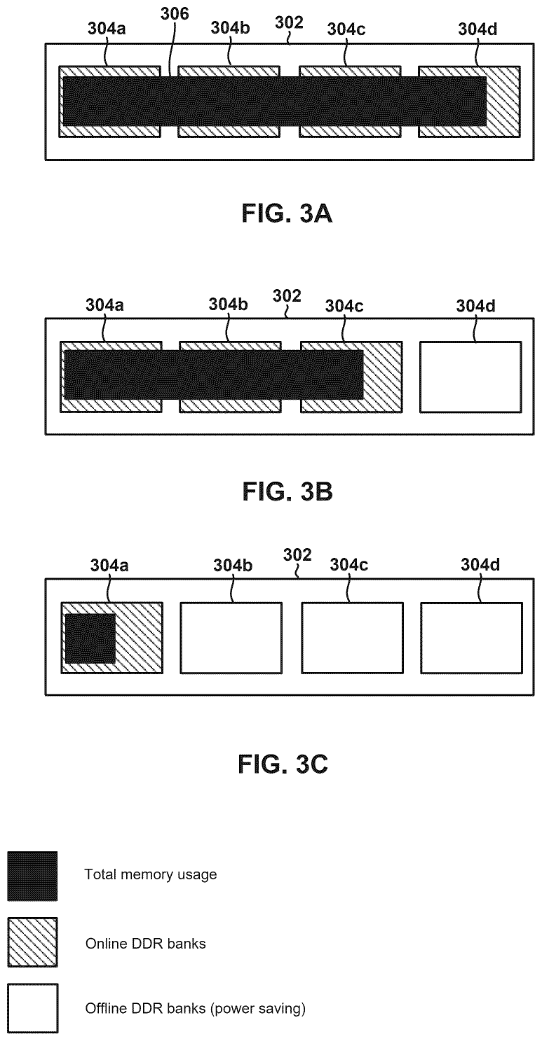

FIGS. 3A-3C illustrate that double data rate (DDR) memory banks 304a-304d of a memory 302 may be dynamically activated or deactivated based on the characteristics and/or workload of the currently active container.

In the example illustrated in FIG. 3A, all of the DDR banks 304a-304d are online DDR banks. The computing device may have activated the DDR banks 304a-304d in response to determining that the current total memory usage 306 of the currently active container requires the use of all of the available DDR banks 304a-304d. As another example, the computing device may have activated the DDR banks 304a-304d in response to determining that the currently active container is an Android user space instance 136, which includes robust features and/or typically uses a large amount of memory resources.

In the example illustrated in FIG. 3B, DDR bank 304d has been deactivated by the computing device for additional power savings. For example, the computing system may dynamically power off DDR bank 304d in response to determining that the currently active container is a Linux embedded user space instance 132 that does not require the use of all the available memory resources.

In the example illustrated in FIG. 3C, DDR banks 304b-304d have all been deactivated by the computing device for further power savings. For example, the computing system may dynamically deactivate DDR banks 304b-304d in response to determining that the currently active container is an OpenWrt user space instance 130 that does not require the use of a significant amount of memory resources.

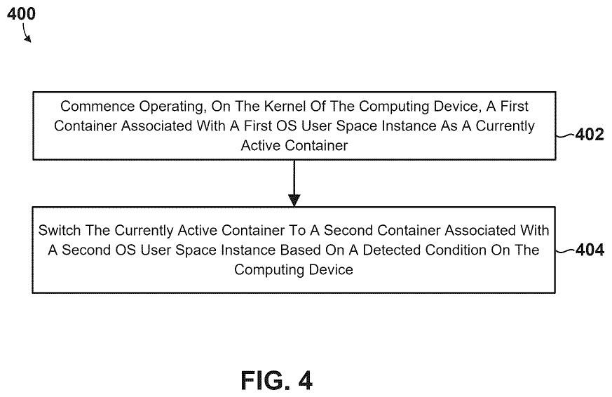

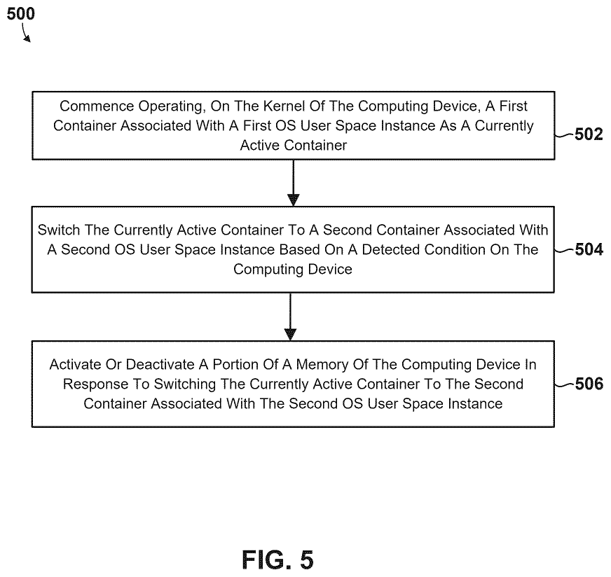

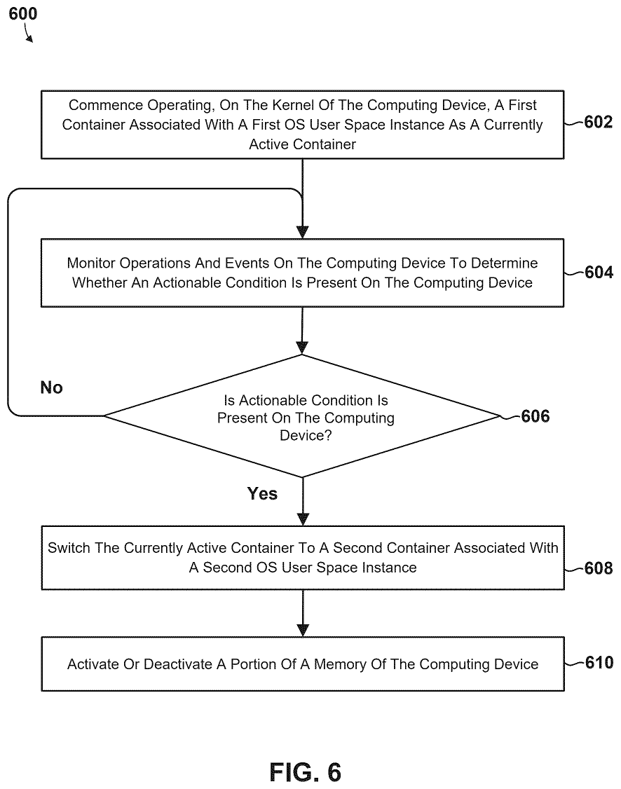

FIGS. 4-6 illustrate methods 400, 500, 600 of operating multiple OS user space instances that share a kernel of a computing device in accordance with various embodiments. Methods 400, 500, 600 may be performed by one or more processors in a computing device (e.g., IOT device).

With reference to FIG. 1-4, in block 402 of method 400, the computing device may commence operating, on the kernel of the computing device, a first container associated with a first OS user space instance as a currently active container.

In block 404, the computing device may switch the currently active container to a second container associated with a second OS user space instance based on a detected condition on the computing device. In some embodiments, the detected condition may be that a trigger communication message was received from an external source. As such, in some embodiments, the operations of switching the currently active container to the second container associated with the second OS user space instance in block 404 may be performed in response to receiving a trigger from an external source.

In some embodiments, the detected condition may be that a user input was received on the computing device. Accordingly, in some embodiments, switching the currently active container to the second container associated with the second OS user space instance based on the detected condition on the computing device in block 404 may include switching the currently active container to the second container in response to receiving the user input on the computing device.

In some embodiments, in block 404, the computing device may switch the currently active container to a second container associated with a second OS user space instance based on an operating condition of a software application program operating on the computing device. That is, in some embodiments, the detected condition may relate to an operating condition of a software application program, such as a new software application program been launched on the computing device, changes in a the operating state (e.g., idle, active, etc.) of the software application program, a performance characteristic of the software application program, a memory usage characteristic of the software application program, an energy consumption characteristic of the software application program, etc.

In some embodiments, in block 404, the computing device may switch the currently active container to a second container associated with a second OS user space instance based on a device conditions, such the amount of time one or more processors of the computing device have remained idle, the amount of memory used by the processors, the amount of energy used by the processors, etc.

In some embodiments, in block 404, the currently active container may be a container associated with an OpenWrt user space instance, a container associated with a Linux embedded user space instance, a container associated with an Ubuntu user space instance, or a container associated with an Android user space instance. In some embodiments, in block 404, the computing device may switch the currently active container to a container associated with an OpenWrt user space instance, a container associated with a Linux embedded user space instance, a container associated with an Ubuntu user space instance, or a container associated with an Android user space instance.

With reference to FIGS. 1-5, in blocks 502 and 504 of method 500, the computing device may perform the same or similar operations discussed above with reference to blocks 402 and 404 of method 400. In particular, in block 502, the computing device may commence operating, on the kernel of the computing device, a first container associated with a first OS user space instance as a currently active container. In block 504, the computing device may switch the currently active container to a second container associated with a second OS user space instance based on a detected condition on the computing device.

In block 506, the computing device may activate or deactivate a portion of a memory of the computing device in response to switching the currently active container to the second container associated with the second OS user space instance. By intelligently and dynamically switching the currently active container in block 504, and dynamically activating or deactivating all or portions of the memories in block 506, the method 500 allows the computing device to process a variety of different tasks while balancing tradeoffs between the performance, memory usage and/or power consumption characteristics of the computing device.

With reference to FIGS. 1-6, in block 602 method 600, the computing device may perform the same or similar operations discussed above with reference to block 402 of method 400 or block 502 of method 500.

In block 604, the computing device may monitor operations and events on the computing device to determine whether an actionable condition is present on the computing device. As examples, in block 604, the computing device may monitor actions or operations of software applications, changes in the performance, memory usage, and/or energy consumption characteristics of the software applications, actions or operations of hardware components (e.g., the amount of time the processor has remained idle, the amount of memory used by the processor, the amount of energy used by the processor, etc.), system resource usage, transmissions or communications of the computing device, library application programming interface (API) calls, system calls, file-system and networking sub-system operations, etc.

In determination block 606, the computing device may determine whether an actionable condition is present on the computing device. For example, the computing device may determine the characteristics of the current operating system user space instance (e.g., Linux Embedded, etc.) and whether the current conditions present on the computing device require a more heavyweight operating system (e.g., Android, etc.) and/or whether a more lightweight operating system (e.g., OpenWRT, etc.) would be adequate to process the current tasks. The computing device may determine that an actionable condition is present on the computing device in response to determining that the current conditions support or require a lightweight operating system or a more heavyweight operating system.

As another example, in block 606 the computing device may determine, based on a result of the monitoring in block 604, whether a software application (e.g., point of sales software, QR code scanning software, multimedia streaming software, etc.) has been launched on the device or changed states (e.g., transitioned from idle to active, etc.). The computing device may also determine the performance, memory usage, and/or energy consumption characteristics of the software application program. Based on these characteristics, the computing device may determine whether the software application program could operate on a lightweight operating system with a small memory footprint, or whether the software application program requires a more heavyweight, robust or complex operating system with more features and a larger memory footprint. The computing device may determine that an actionable condition is present on the computing device in response to determining that the current conditions support or require a lighter or more heavyweight operating system.

In response to determining that there are no actionable conditions present on the computing device (i.e., determination block 606=“No”), the computing device may continue to monitor operations and events on the computing device in block 604.

In response to determining that there is an actionable condition present on the computing device (i.e., determination block 606=“Yes”), the computing device may switch the currently active container to a second container associated with a second OS user space instance in block 608.

In block 610, the computing device may activate or deactivate a portion of a memory of the computing device in response to switching the currently active container to the second container associated with the second OS user space instance. For example, if the current operating system user space instance is a Linux Embedded user space instance and the actionable condition relates to the launching of QR code scanning software, in block 608, the computing device may switch the container associated with the Linux Embedded user space instance to a container associated with a OpenWRT user space instance. In block 610, the computing device may deactivate a portion of a memory of the computing device to reduce power consumption on the computing device.

As another example, if the current operating system user space instance is a Linux Embedded user space instance and the actionable condition relates to the launching of multimedia streaming software, in block 608, the computing device could switch the container associated with the Linux Embedded user space instance to another container associated with an Android user space instance. In block 610, the computing device may activate additional portions of memory to better support the multimedia streaming software or Android user space instance and/or to improve the performance of the computing device.

Various embodiments may be implemented on a number of single processor and multiprocessor computer systems, including a system-on-chip (SOC) or system in a package (SIP).

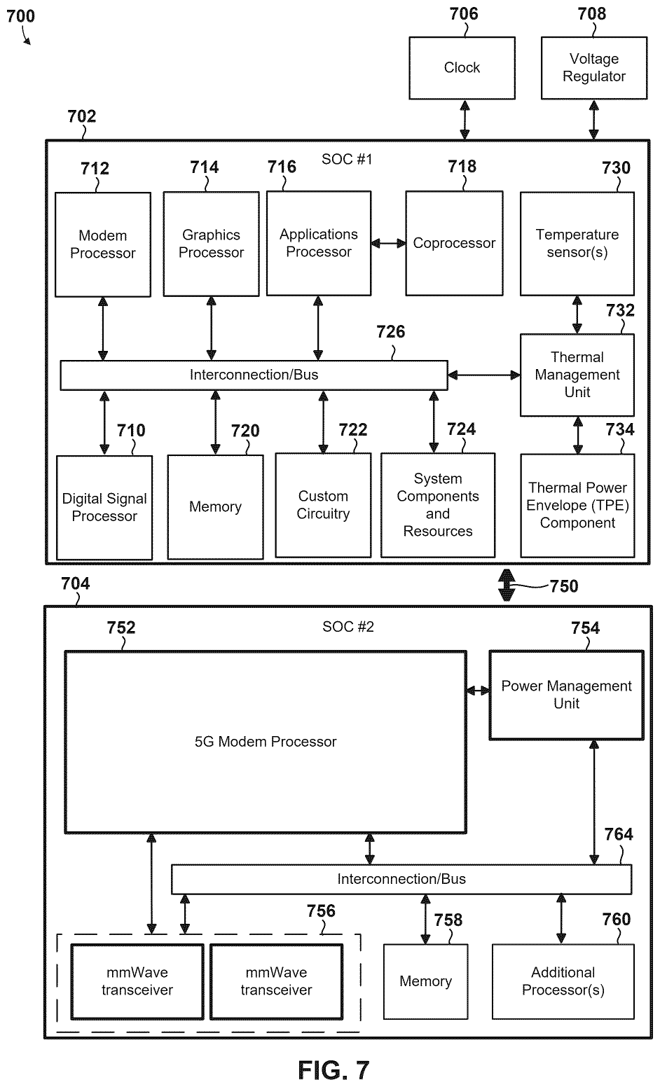

FIG. 7 illustrates an example computing system or SIP 700 architecture that may be used in wireless devices implementing various embodiments.

With reference to FIG. 7, the illustrated example SIP 700 includes a two SOCs 702, 704, a clock 706, and a voltage regulator 708. In some embodiments, the first SOC 702 operate as central processing unit (CPU) of the wireless device that carries out the instructions of software application programs by performing the arithmetic, logical, control and input/output (I/O) operations specified by the instructions. In some embodiments, the second SOC 704 may operate as a specialized processing unit. For example, the second SOC 704 may operate as a specialized 5G processing unit responsible for managing high volume, high speed (e.g., 5 Gbps, etc.), and/or very high frequency short wave length (e.g., 28 GHz mmWave spectrum, etc.) communications.

The first SOC 702 may include a digital signal processor (DSP) 710, a modem processor 712, a graphics processor 714, an application processor 716, one or more coprocessors 718 (e.g., vector co-processor) connected to one or more of the processors, memory 720, custom circuity 722, system components and resources 724, an interconnection/bus module 726, one or more temperature sensors 730, a thermal management unit 732, and a thermal power envelope (TPE) component 734. The second SOC 704 may include a 5G modem processor 752, a power management unit 754, an interconnection/bus module 764, a plurality of mm Wave transceivers 756, memory 758, and various additional processors 760, such as an applications processor, packet processor, etc.

Each processor 710, 712, 714, 716, 718, 752, 760 may include one or more cores, and each processor/core may perform operations independent of the other processors/cores. For example, the first SOC 702 may include a processor that executes a first type of operating system (e.g., FreeBSD, LINUX, OS X, ANDROID etc.) and a processor that executes a second type of operating system (e.g., MICROSOFT WINDOWS 10). In addition, any or all of the processors 710, 712, 714, 716, 718, 752, 760 may be included as part of a processor cluster architecture (e.g., a synchronous processor cluster architecture, an asynchronous or heterogeneous processor cluster architecture, etc.).

The first and second SOC 702, 704 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 724 of the first SOC 702 may include power amplifiers, voltage regulators, oscillators, phase-locked loops, peripheral bridges, data controllers, memory controllers, system controllers, access ports, timers, and other similar components used to support the processors and software clients running on a wireless device. The system components and resources 724 and/or custom circuitry 722 may also include circuitry to interface with peripheral devices, such as cameras, electronic displays, wireless communication devices, external memory chips, etc.

The first and second SOC 702, 704 may communicate via interconnection/bus module 750. The various processors 710, 712, 714, 716, 718, may be interconnected to one or more memory elements 720, system components and resources 724, and custom circuitry 722, and a thermal management unit 732 via an interconnection/bus module 726. Similarly, the processor 752 may be interconnected to the power management unit 754, the mmWave transceivers 756, memory 758, and various additional processors 760 via the interconnection/bus module 764. The interconnection/bus module 726, 750, 764 may include an array of reconfigurable logic gates and/or implement a bus architecture (e.g., CoreConnect, AMBA, etc.). Communications may be provided by advanced interconnects, such as high-performance networks-on chip (NoCs).

The first and/or second SOCs 702, 704 may further include an input/output module (not illustrated) for communicating with resources external to the SOC, such as a clock 706 and a voltage regulator 708. Resources external to the SOC (e.g., clock 706, voltage regulator 708) may be shared by two or more of the internal SOC processors/cores.

In addition to the example SIP 700 discussed above, various embodiments may be implemented in a wide variety of computing systems, which may include a single processor, multiple processors, multicore processors, or any combination thereof.

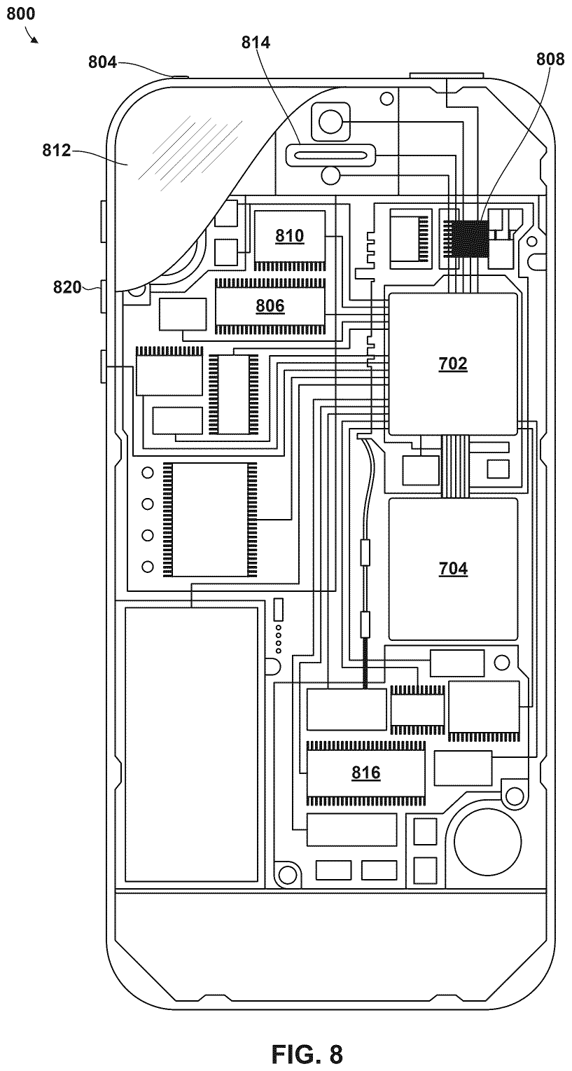

Various embodiments may be implemented on a variety of computing devices, an example of which is illustrated in FIG. 8 in the form of a smartphone 800. The smartphone 800 may include a first SOC 702 (e.g., a SOC-CPU) coupled to a second SOC 704 (e.g., a 5G capable SOC). The first and second SOCs 702, 704 may be coupled to internal memory 806, 816, a display 812, and to a speaker 814. Additionally, the smartphone 800 may include an antenna 804 for sending and receiving electromagnetic radiation that may be connected to a wireless data link and/or cellular telephone transceiver 808 coupled to one or more processors in the first and/or second SOCs 702, 704. Smartphones 800 typically also include menu selection buttons or rocker switches 820 for receiving user inputs.

A typical smartphone 800 also includes a sound encoding/decoding (CODEC) circuit 810, which digitizes sound received from a microphone into data packets suitable for wireless transmission and decodes received sound data packets to generate analog signals that are provided to the speaker to generate sound. Also, one or more of the processors in the first and second SOCs 702, 704, wireless transceiver 808 and CODEC 810 may include a digital signal processor (DSP) circuit (not shown separately).

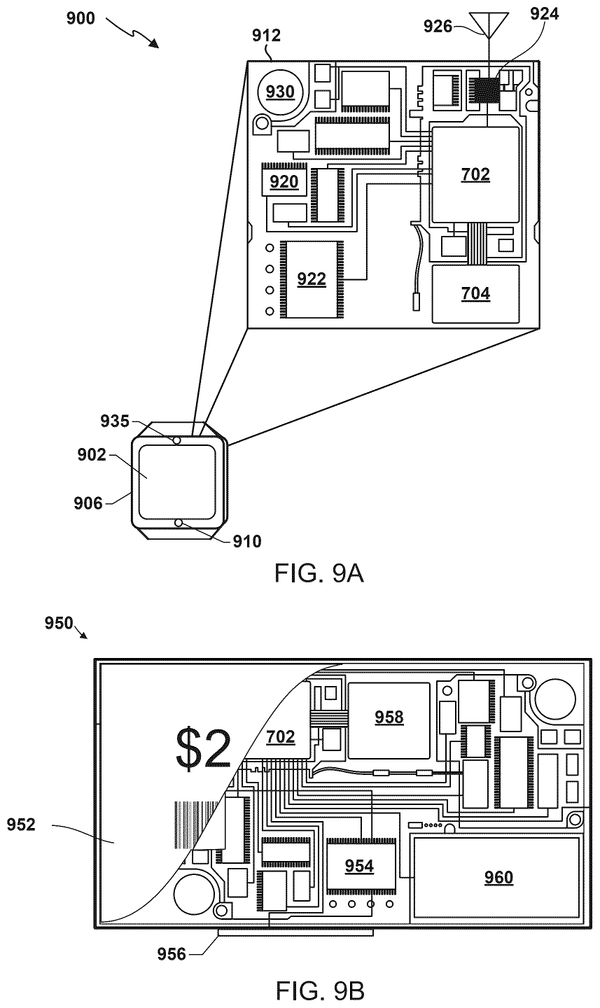

FIG. 9A is a component block diagram of an internet of things (IOT) device in the form of a wearable IOT device 900 suitable for use with various embodiments. With reference to FIGS. 1-9A, a wearable IOT device 900 may include a body 906 housing a display device 902 that is configured to display information, a camera 935 configured to capture still images or video, and a microphone 910 positioned and configured to record sounds in the vicinity. The display device 902 also may be a touch-sensitive display configured to receive a user input. In some embodiments, wearable IOT device 900 may include other sensors (e.g., a thermometer, heart rate monitor, body temperature sensor, pulse oximeter, etc.) for collecting information pertaining to environment and/or user conditions.

The IOT device 900 may include a processing system 912 that includes processing and communication SOCs 702, 704 which may include one or more processors (e.g., 710, 712, 714, 716, 718, 752, and 760), one or more of which may be configured with processor-executable instructions to perform operations of various embodiments. The processing and communications SOCs 702, 704 may be coupled to internal sensors 920, internal memory 922, and communication circuitry 924 coupled one or more antenna 926 for establishing a wireless communication link. The internal sensors 920 may include an inertial measurement unit (IMU) that includes electronic gyroscopes, accelerometers, and a magnetic compass configured to measure movements and orientation of the wearable IOT device 900. The processing system 912 may further include a power source such as a rechargeable battery 930 coupled to the SOCs 702, 704 as well as communication circuitry 924 and internal sensors 920.

FIG. 9B is a component block diagram of another example IOT device in the form of a point-of-sale display device or electronic shelf label 950 suitable for use with various embodiments. With reference to FIGS. 1-9B, an electronic shelf label 950 may include a display 952 coupled to a processor 702 (e.g., an SoC) that is coupled to internal memory 958. The processor 702 may configured with processor-executable instructions stored in the internal memory 958 that cause the processor to perform operations of various embodiments. The processor 702 may be coupled to a wireless transceiver 954, such as a Bluetooth Low Energy (BLE) transceiver or a combination BLE and Wi-Fi transceiver, that is coupled to an antenna 956 for sending and receiving radio frequency (RF) signals. An electronic shelf label 950 may be powered by a battery 960, freeing the display 952 from having to be connected to a wired power supply. Alternatively, the electronic shelf label 950 may be powered from an external power source (not shown).

The processors 702, 704 of a smart phone 800 and IOT devices 900, 950 may include any programmable microprocessor, microcomputer or multiple processor chip or chips that can be configured by software instructions (applications) to perform a variety of functions, including the functions of various embodiments described below. In some mobile devices, multiple processors may be provided, such as one processor within an SOC 704 dedicated to wireless communication functions and one processor within an SOC 702 dedicated to running other applications. Typically, software applications may be stored the memory 806, 816, 922, 958 before the instructions are accessed and loaded into the processor 702, 704 for execution.

Implementation examples are described in the following paragraphs. While some of the following implementation examples are described in terms of example methods, further example implementations may include: the example methods discussed in the following paragraphs implemented by an computing device, such as an IOT device, including means for performing functions of the example methods; the example methods discussed in the following paragraphs implemented in a processor that is configured to perform the operations of the example methods; and the example methods discussed in the following paragraphs implemented as a non-transitory processor-readable storage medium having stored thereon processor-executable instructions configured to cause a processor to perform the operations of the example methods.

Example 1. A method of operating multiple operating system (OS) user space instances that share a kernel of a computing device, the method including operating, by a processor in the computing device on the kernel of the computing device, a first container associated with a first OS user space instance as a currently active container, and switching the currently active container to a second container associated with a second OS user space instance based on a detected condition on the computing device.

Example 2. The method of example 1, further including activating or deactivating a portion of a memory of the computing device in response to switching the currently active container to the second container associated with the second OS user space instance.

Example 3. The method of any of examples 1 and 2, in which switching the currently active container to the second container associated with the second OS user space instance based on the detected condition on the computing device includes switching the currently active container to the second container associated with the second OS user space instance in response to receiving a trigger from an external source.

Example 4. The method of any of examples 1-3, in which switching the currently active container to the second container associated with the second OS user space instance based on the detected condition on the computing device includes switching the currently active container to the second container associated with the second OS user space instance in response to receiving user input on the computing device.

Example 5. The method of any of examples 1-4, in which switching the currently active container to the second container associated with the second OS user space instance based on the detected condition on the computing device includes switching the currently active container to the second container associated with the second OS user space instance based on an operating condition of a software application program operating on the computing device.

Example 6. The method of any of examples 1-5, in which switching the currently active container to the second container associated with the second OS user space instance based on the operating condition of the software application program operating on the computing device includes switching the currently active container to the second container associated with the second OS user space instance based on at least one of: a performance characteristic of the software application program, a memory usage characteristic of the software application program, or an energy consumption characteristic of the software application program.

Example 7. The method of any of examples 1-6, in which switching the currently active container to the second container associated with the second OS user space instance based on the detected condition on the computing device includes switching the currently active container to the second container associated with the second OS user space instance based on at least one of: an amount of time the processor has remained idle, an amount of memory used by the processor, or an amount of energy used by the processor.

Example 8. The method of any of examples 1-7, in which switching the currently active container to the second container associated with the second OS user space instance based on the detected condition on the computing device includes switching the currently active container to one of: a container associated with an Open Wrt user space instance, a container associated with a Linux embedded user space instance, a container associated with an Ubuntu user space instance, or a container associated with an Android user space instance.

Example 9. The method of any of examples 1-8, in which the computing device is an internet of things (IOT) device.

Example 10. A computing device including, a memory that includes memory segments that can each be activated or deactivated, and a processor coupled to the memory and configured to support multiple operating system (OS) user space instances that share a kernel. The processor may be configured to operate, on the kernel, a first container associated with a first OS user space instance as a currently active container, and switch the currently active container to a second container associated with a second OS user space instance based on a detected condition.

Example 11. The computing device of example 10, in which the processor is further configured to activate or deactivate one or more of the memory segments in response to switching the currently active container to the second container associated with the second OS user space instance.

Example 12. The computing device of any of examples 10 and 11, in which the processor is configured to switch the currently active container to the second container associated with the second OS user space instance based on the detected condition by switching the currently active container to the second container associated with the second OS user space instance in response to receiving a trigger from an external source.

Example 13. The computing device of any of examples 10-12, in which the processor is configured to switch the currently active container to the second container associated with the second OS user space instance based on the detected condition by switching the currently active container to the second container associated with the second OS user space instance in response to receiving user input on the computing device.

Example 14. The computing device of any of examples 10-13, in which the processor is configured to switch the currently active container to the second container associated with the second OS user space instance based on the detected condition by switching the currently active container to the second container associated with the second OS user space instance based on an operating condition of a software application program operating on the computing device.

Example 15. The computing device of any of examples 10-14, in which the processor is configured to switch the currently active container to the second container associated with the second OS user space instance based on the operating condition of the software application program operating by switching the currently active container to the second container associated with the second OS user space instance based on at least one of: a performance characteristic of the software application program, a memory usage characteristic of the software application program, or an energy consumption characteristic of the software application program.

Example 16. The computing device of any of examples 10-15, in which the processor is configured to switch the currently active container to the second container associated with the second OS user space instance based on the detected condition by switching the currently active container to the second container associated with the second OS user space instance based on at least one of: an amount of time the processor has remained idle, an amount of memory used by the processor, or an amount of energy used by the processor.

Example 17. The computing device of any of examples 10-16, in which the processor is configured to switch the currently active container to the second container associated with the second OS user space instance based on the detected condition by switching the currently active container to one of: a container associated with an OpenWrt user space instance, a container associated with a Linux embedded user space instance, a container associated with an Ubuntu user space instance, or a container associated with an Android user space instance.

Example 18. The computing device of any of examples 10-17, in which the computing device is an internet-of-things (IOT) device.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a wireless device and the wireless device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

A number of different cellular and mobile communication services and standards are available or contemplated in the future, all of which may implement and benefit from various embodiments. Such services and standards include, e.g., third generation partnership project (3GPP), long term evolution (LTE) systems, third generation wireless mobile communication technology (3G), fourth generation wireless mobile communication technology (4G), fifth generation wireless mobile communication technology (5G), global system for mobile communications (GSM), universal mobile telecommunications system (UMTS), 3GSM, general packet radio service (GPRS), code division multiple access (CDMA) systems (e.g., cdmaOne, CDMA1020TM), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), and integrated digital enhanced network (iDEN). Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods 400-600 may be substituted for or combined with one or more operations of the methods 400-600.

The processors discussed in this application may be any programmable microprocessor, microcomputer or multiple processor chip or chips that can be configured by software instructions (applications) to perform a variety of functions, including the functions of various embodiments described above. In some devices, multiple processors may be provided, such as one processor dedicated to wireless communication functions and one processor dedicated to running other applications. Typically, software applications may be stored in the internal memory before they are accessed and loaded into the processors. The processors may include internal memory sufficient to store the application software instructions. In many devices, the internal memory may be a volatile or nonvolatile memory, such as flash memory, or a mixture of both. For the purposes of this description, a general reference to memory refers to memory accessible by the processors including internal memory or removable memory plugged into the device and memory within the processors themselves. Additionally, as used herein, any reference to a memory may be a reference to a memory storage and the terms may be used interchangeable.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, components, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module and/or processor-executable instructions, which may reside on a non-transitory computer-readable or non-transitory processor-readable storage medium. Non-transitory server-readable, computer-readable or processor-readable storage media may be any storage media that may be accessed by a computer or a processor. By way of example but not limitation, such non-transitory server-readable, computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, DVD, floppy disk, and Blu-ray disc where disks usually reproduce data magnetically, while discs reproduce data optically with lasers. Combinations of the above are also included within the scope of non-transitory server-readable, computer-readable and processor-readable media. Additionally, the operations of a method or algorithm may reside as one or any combination or set of codes and/or instructions on a non-transitory server-readable, processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the claims not intended to be limited to the embodiments shown herein but are to be accorded the widest scope consistent with the following claims and the principles and novel features disclosed herein.

What is claimed is:

1. A computing device, comprising:
a memory including memory segments that can each be activated or deactivated; and
a processor coupled to the memory and configured to support multiple operating system (OS) user space instances that share a kernel, wherein the processor is configured to:
operate, on the kernel, a first container associated with a first OS user space instance as a currently active container; and
switch the currently active container to a second container associated with a second OS user space instance based on a detected condition.

2. The computing device of claim 1, wherein the processor is further configured to activate or deactivate one or more of the memory segments in response to switching the currently active container to the second container associated with the second OS user space instance.

3. The computing device of claim 1, wherein the processor is configured to switch the currently active container to the second container associated with the second OS user space instance based on the detected condition by switching the currently active container to the second container associated with the second OS user space instance in response to receiving a trigger from an external source.

4. The computing device of claim 1, wherein the processor is configured to switch the currently active container to the second container associated with the second OS user space instance based on the detected condition by switching the currently active container to the second container associated with the second OS user space instance in response to receiving user input on the computing device.

5. The computing device of claim 1, wherein the processor is configured to switch the currently active container to the second container associated with the second OS user space instance based on the detected condition by switching the currently active container to the second container associated with the second OS user space instance based on an operating condition of a software application program operating on the computing device.

6. The computing device of claim 5, wherein the processor is configured to switch the currently active container to the second container associated with the second OS user space instance based on the operating condition of the software application program operating by switching the currently active container to the second container associated with the second OS user space instance based on at least one of:
a performance characteristic of the software application program;
a memory usage characteristic of the software application program; or
an energy consumption characteristic of the software application program.

7. The computing device of claim 1, wherein the processor is configured to switch the currently active container to the second container associated with the second OS user space instance based on the detected condition by switching the currently active container to the second container associated with the second OS user space instance based on at least one of:
an amount of time the processor has remained idle;
an amount of memory used by the processor; or
an amount of energy used by the processor.

8. The computing device of claim 1, wherein the processor is configured to switch the currently active container to the second container associated with the second OS user space instance based on the detected condition by switching the currently active container to one of:
a container associated with an OpenWrt user space instance;
a container associated with a Linux embedded user space instance;
a container associated with an Ubuntu user space instance; or
a container associated with an Android user space instance.

9. The computing device of claim 1, wherein the computing device is an internet-of- things (IOT) device.

10. A method of operating multiple operating system (OS) user space instances that share a kernel of a computing device, the method comprising:
operating, by a processor in the computing device on the kernel of the computing device, a first container associated with a first OS user space instance as a currently active container; and
switching the currently active container to a second container associated with a second OS user space instance based on a detected condition on the computing device.

11. The method of claim 10, further comprising activating or deactivating a portion of a memory of the computing device in response to switching the currently active container to the second container associated with the second OS user space instance.

12. The method of claim 10, wherein switching the currently active container to the second container associated with the second OS user space instance based on the detected condition on the computing device comprises switching the currently active container to the second container associated with the second OS user space instance in response to receiving a trigger from an external source.

13. The method of claim 10, wherein switching the currently active container to the second container associated with the second OS user space instance based on the detected condition on the computing device comprises switching the currently active container to the second container associated with the second OS user space instance in response to receiving user input on the computing device.

14. The method of claim 10, wherein switching the currently active container to the second container associated with the second OS user space instance based on the detected condition on the computing device comprises switching the currently active container to the second container associated with the second OS user space instance based on an operating condition of a software application program operating on the computing device.

15. The method of claim 14, wherein switching the currently active container to the second container associated with the second OS user space instance based on the operating condition of the software application program operating on the computing device comprises switching the currently active container to the second container associated with the second OS user space instance based on at least one of:
a performance characteristic of the software application program;
a memory usage characteristic of the software application program; or
an energy consumption characteristic of the software application program.

16. The method of claim 10, wherein switching the currently active container to the second container associated with the second OS user space instance based on the detected condition on the computing device comprises switching the currently active container to the second container associated with the second OS user space instance based on at least one of:
an amount of time the processor has remained idle;
an amount of memory used by the processor; or
an amount of energy used by the processor.

17. The method of claim 10, wherein switching the currently active container to the second container associated with the second OS user space instance based on the detected condition on the computing device comprises switching the currently active container to one of:
a container associated with an OpenWrt user space instance;
a container associated with a Linux embedded user space instance;
a container associated with an Ubuntu user space instance; or
a container associated with an Android user space instance.

18. The method of claim 10, wherein the computing device is an internet of things (IOT) device.

19. A computing device, comprising:
a memory;
means for operating, on a kernel of the computing device, a first container associated with a first OS user space instance as a currently active container; and
means for switching the currently active container to a second container associated with a second OS user space instance based on a detected condition.

20. The computing device of claim 19, further comprising means for activating or deactivating a portion of the memory in response to switching the currently active container to the second container associated with the second OS user space instance.

21. The computing device of claim 19, wherein the means for switching the currently active container to the second container associated with the second OS user space instance based on the detected condition comprises means for switching the currently active container to the second container associated with the second OS user space instance in response to receiving a trigger from an external source.

22. The computing device of claim 19, wherein the means for switching the currently active container to the second container associated with the second OS user space instance based on the detected condition comprises means for switching the currently active container to the second container associated with the second OS user space instance in response to receiving user input.

23. The computing device of claim 19, wherein the means for switching the currently active container to the second container associated with the second OS user space instance based on the detected condition comprises means for switching the currently active container to the second container associated with the second OS user space instance based on an operating condition of a software application program operating.

24. The computing device of claim 23, wherein the means for switching the currently active container to the second container associated with the second OS user space instance based on the operating condition of the software application program operating comprises means for switching the currently active container to the second container associated with the second OS user space instance based on at least one of:
a performance characteristic of the software application program;
a memory usage characteristic of the software application program; or
an energy consumption characteristic of the software application program.

25. The computing device of claim 19, wherein the means for switching the currently active container to the second container associated with the second OS user space instance based on the detected condition comprises means for switching the currently active container to the second container associated with the second OS user space instance based on at least one of:
an amount of time a processor has remained idle;
an amount of memory used by the processor; or
an amount of energy used by the processor.

26. The computing device of claim 19, wherein the means for switching the currently active container to the second container associated with the second OS user space instance based on the detected condition comprises means for switching the currently active container to one of:
a container associated with an OpenWrt user space instance;
a container associated with a Linux embedded user space instance;
a container associated with an Ubuntu user space instance; or
a container associated with an Android user space instance.

27. The computing device of claim 19, wherein the computing device is an internet- of-things (IOT) device.

28. A non-transitory computer readable storage medium having stored thereon processor-executable software instructions configured to cause a processor of a computing device to perform operations for operating multiple operating system (OS) user space instances that share a kernel of the computing device, the operations comprising:
operating, on the kernel of the computing device, a first container associated with a first OS user space instance as a currently active container; and
switching the currently active container to a second container associated with a second OS user space instance based on a detected condition.

29. The non-transitory computer readable storage medium of claim 28, wherein the stored processor-executable software instructions are configured to cause the processor to perform operations further comprising activating or deactivating a portion of a memory of the computing device in response to switching the currently active container to the second container associated with the second OS user space instance.

30. The non-transitory computer readable storage medium of claim 28, wherein the stored processor-executable software instructions are configured to cause the processor to perform operations such that switching the currently active container to the second container associated with the second OS user space instance based on the detected condition comprises switching the currently active container to the second container associated with the second OS user space instance in response to receiving a trigger from an external source.
